(19) United States
(12) Patent Application Publication
(10) Pub. No.: US 2025/0158792 A1
(43) Pub. Date: May 15, 2025

(54) DYNAMIC UPLINK BAND TRANSMISSION

(71) Applicant: Google LLC, MOUNTAIN VIEW, CA (US)

(72) Inventors: Jibing WANG, San Jose, CA (US); Aamir AKRAM, San Jose, CA (US); Erik STAUFFER, Sunnyvale, CA (US)

(21) Appl. No.: 18/836,259

(22) PCT Filed: Feb. 15, 2023
(86) PCT No.: PCT/US2023/013150

§ 371 Date: Aug. 6, 2024

Related U.S. Application Data
(60) Provisional application No. 63/310,394, filed on Feb. 15, 2022.

(51) Int. Cl. H04L 5/00; H04L 27/26; H04W 74/0833

(52) U.S. Cl. CPC H04L 5/0092; H04L 27/2656; H04W 74/0833

(57) ABSTRACT

A method implemented by a RAN includes transmitting, by a first node of the RAN and to a user device, an indication of two or more candidate UL bands, the first node using a first operating band for DL communications to user devices, and each of the candidate UL bands being outside of the first operating band. The method also includes receiving from the user device an indication of a selection, from among the two or more candidate UL bands, of a UL band for UL communications from the user device to the RAN. The method further includes communicating bi-directionally with the user device using the UL band for the UL communications from the user device to the RAN, and using a DL band within the first operating band for DL communications from the RAN to the user device.

### CROSS REFERENCE TO RELATED APPLICATION

his application claims the benefit of and priority to U.S. Provisional Application Ser. No. 63/310,394, entitled “Dynamic Uplink Band Transmission” and filed on Feb. 15, 2022, which is expressly incorporated by reference herein in its entirety.

### FIELD OF THE DISCLOSURE

This disclosure relates to wireless communications and, more particularly, to bi-directional (uplink/downlink) communications between user devices and network nodes.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

In telecommunication systems such as Evolved Universal Terrestrial Radio Access (EUTRA) and fifth-generation (5G) New Radio (NR), a user device (also known as a user equipment or “UE”) in some scenarios can concurrently utilize radios/resources of multiple radio access network (RAN) nodes (e.g., base stations or components of a distributed base station or disaggregated base station) that are interconnected by a backhaul, in what is referred to as dual connectivity (DC) operation. These network nodes may all be nodes of the same radio access technology (RAT), or may include nodes of different RATs in what is known as multi-radio or multi-RAT DC (MR-DC). Example DC configurations include EUTRA and NR dual connectivity (EN-DC), and NR-only dual connectivity (NR-DC). In other scenarios, a UE utilizes resources of one network node at a time, in single connectivity (SC).

The Third Generation Partnership Project (3GPP) has proposed that UEs supporting 5G NR be able to operate in a first frequency range 1 (FR1) and/or a second frequency range (FR2). FR1 covers 410 MHz to 7.125 GHz and includes a number of operating bands (e.g., n1, n2, etc.) each designated for either frequency division duplex (FDD) communications, time division duplex (TDD) communications, supplementary DL (SDL) communications, or supplementary UL (SUL) communications. FR2 covers 24.250 to 52.600 GHz and includes a smaller number of operating bands (n257, n258, etc.) each designated for TDD communications. FR1 and FR2 support different carrier bandwidths and subcarrier spacings. The SUL operating bands are generally intended to extend bi-directional coverage, for a given UL transmission power, by using the relatively low frequencies of FR1 for the UL (due to the propagation qualities of lower frequency signals) while using the relatively high frequencies of FR2 for the DL.

Conventional FDD in cellular systems, while in some ways more efficient than TDD, has several drawbacks. For example, UL transmissions in certain frequency ranges (e.g., FR2 operating bands, or higher frequency FR1 operating bands such as n94) have specific absorption rate (SAR) compliance constraints that are more difficult to satisfy relative to lower frequency ranges (e.g., low- to or mid-frequency operating bands in FR1, such as n5 or n2). While some operating bands of FR1 support FDD, there is a relatively small frequency difference between the UL and DL frequencies in a given operating band. Thus, in several hardware implementations, the use of a particular FDD operating band may cause SAR compliance problems on the UL. Moreover, the relatively small difference between UL and DL frequencies necessitates a diplexer, which can be lossy and expensive. Further still, certain UEs (e.g., typical wearable devices) have only one antenna per operating band, and optimizing that single antenna for the DL frequency will degrade UL performance (and vice versa). While some of these issues can be addressed in part by using SUL, problems remain. For example, SUL is relatively inflexible, requiring the support of conventional carrier pairs having both a UL and a DL in the same operating band, and requiring that the base station configure the UE to use both the conventionally-paired UL (in the same operating band as the DL) and the SUL in the other operating band.

### SUMMARY

UEs and RANs of this disclosure can support one or more of the dynamic UL band transmission techniques disclosed herein. In particular, increased flexibility of UL band selection is provided by decoupling the UL band from the DL band, such that the UL can use a different operating band than the DL, and in some implementations, such that no conventionally-paired UL need be used at all. As used herein (with respect to the UL and/or the DL), the term “band” may refer to an operating band, or to a portion of an operating band. Moreover, references to a band or band transmissions being “in” or “within” an operating band, or to band transmissions “using” an operating band, etc., can mean that the band is coextensive in frequency with the entire operating band, or that the band is a narrower frequency range within the wider operating band, depending on the implementation and/or scenario.

In some implementations, DL band selection occurs in a conventional manner, e.g., by a base station of the RAN transmitting (broadcasting) a signal synchronization block (SSB) and system information block (SIB). A UE supporting the dynamic UL band techniques disclosed herein can then select a preferred UL band, which need not be paired to, or within the same operating band as, the DL band. The UE may select the UL band from among multiple candidate bands indicated by the base station in a SIB, for example. After selecting the UL band, the UE can request the selected UL band, and the base station may either deny the request (e.g., instead approve a different UL band) or approve the requested UL band. In some implementations, the decoupled UL and DL are supported by different nodes of the RAN (e.g., during EN-DC operation, with an EUTRA base station supporting the UL and an NR base station supporting the DL), e.g., in DC or carrier aggregation (CA) operation. As the term is used herein, a “RAN” may refer to a radio access network of a single RAT (e.g., only NR base stations), the combination of multiple radio access networks of a single RAT (e.g., an NR FR1 network and an NR FR2 network), or the combination of multiple radio access networks of different RATs (e.g., with both EUTRA and NR base stations).

In some implementations and/or scenarios, the UE indicates/requests its selected/preferred UL band upon initial access. For example, the UE may monitor system information broadcast by a base station, and the system information may indicate two or more candidate UL bands that are in a different operating band than the DL band. The UE can then select one of the candidate UL bands for UL communications to the RAN, and send an indication of the selected UL band to the RAN. In some implementations, the UE indicates the selected UL band by using a particular random access channel (RACH) configuration that corresponds to the selected UL band to send a RACH message to the RAN. For example, the base station may broadcast (e.g., in a SIB) a list of candidate UL bands and corresponding RACH configurations (e.g., PRACH frequencies and/or preamble sequences), and the UE may use the particular RACH configuration that corresponds to the selected/preferred UL band. In other implementations, the RAN indicates the candidate UL band(s) (e.g., with corresponding RACH configuration(s)) in an RRC message, such as a dedicated RRC message.

Additionally or alternatively, in some implementations and/or scenarios, the UE can request a new UL band at a later time, after initial access. For example, the UE may detect a triggering event (e.g., local desense caused by interference, or a required transmit power back off for SAR compliance that would cause UL range to be insufficient in the current UL band, etc.), and in response select a new UL band. The UE may indicate the selected UL band to a base station of the RAN in an RRC message, and the base station may approve the selected band in a responsive RRC message, for example. The UE may be aware of the candidate UL bands based on system information that the base station (or another RAN node) broadcasts at an earlier time, for example, or based on a later RRC message (e.g., a dedicated RRC message) that the UE received from the base station or other RAN node.

The above-noted implementations, and/or other implementations disclosed herein, may provide various advantages over conventional techniques, such as increasing flexibility of UL band selection, facilitating compliance with SAR constraints without greatly reducing network coverage, and/or eliminating the need for a diplexer (thereby reducing cost, front-end loss, and/or front-end complexity). These advantages may be particularly important for wearable devices, which tend to have tighter restrictions relating to industrial design, cost, and size/area.

In one example, a method is implemented by one or more nodes of a RAN that supports communications with user devices using a plurality of operating bands each supporting a plurality of frequency channels. The method includes transmitting, by a first node of the one or more nodes and to a user device, an indication of two or more candidate UL bands. The first node uses a first operating band for DL communications to user devices, and each of the two or more candidate UL bands is outside of the first operating band. The method also includes receiving, by processing hardware of the one or more nodes and from the user device, an indication of a selection, from among the two or more candidate UL bands, of a UL band for UL communications from the user device to the RAN. The method further includes communicating, by the processing hardware, bi-directionally with the user device (i) using the UL band for the UL communications from the user device to the RAN and (ii) using a DL band in the first operating band for DL communications from the RAN to the user device.

In another example, one or more nodes of a RAN has processing hardware configured to perform the above method.

In another example, a method is implemented by a user device configured to communicate with a RAN that supports communications with user devices using a plurality of operating bands each supporting a plurality of frequency channels. The method includes receiving, from a first node of the RAN, an indication of two or more candidate UL bands. The first node uses a first operating band for DL communications to user devices, and each of the two or more candidate UL bands is outside of the first operating band. The method also includes selecting, by processing hardware of the user device and from among the two or more candidate UL bands, a UL band for UL communications from the user device to the RAN. The method further includes transmitting an indication of the selection of the UL band to the RAN, and communicating, by the processing hardware, bi-directionally with the RAN (i) using the UL band for the UL communications from the user device to the RAN and (ii) using a DL band in the first operating band for DL communications from the RAN to the user device.

In another example, a user device has processing hardware configured to perform the above method.

### BRIEF DESCRIPTION OF THE DRAWINGS

FIG. 1A is a block diagram of an example wireless communication system in which techniques of this disclosure for dynamic UL band transmission can be implemented;

FIG. 1B is a block diagram of an example base station in which a centralized unit (CU) and distributed units (DUs) operate in the wireless communication system of FIG. 1A;

FIG. 2 is a block diagram of an example protocol stack according to which the UE of FIG. 1A communicates with one or more base stations of FIG. 1A;

FIGS. 3 and 4 are messaging diagrams of example implementations and scenarios in which, upon initial access, the UE of FIG. 1A selects a UL band for communication with the RAN of FIG. 1A;

FIGS. 5 and 6 are messaging diagrams of example implementations and scenarios in which, after the UE or FIG. 1A communicates with the RAN of FIG. 1A using a first UL band, the UE selects a new UL band for communication with the RAN;

FIG. 7 is a flow diagram of an example method, implemented by one or more nodes of a RAN such as the RAN of FIG. 1A, for providing dynamic UL band transmission to a user device such as the UE of FIG. 1A; and

FIG. 8 is a flow diagram of an example method, implemented by a user device such as the UE of FIG. 1A, for utilizing dynamic UL band transmission capabilities supported by a RAN such as the RAN of FIG. 1A.

### DETAILED DESCRIPTION OF THE DRAWINGS

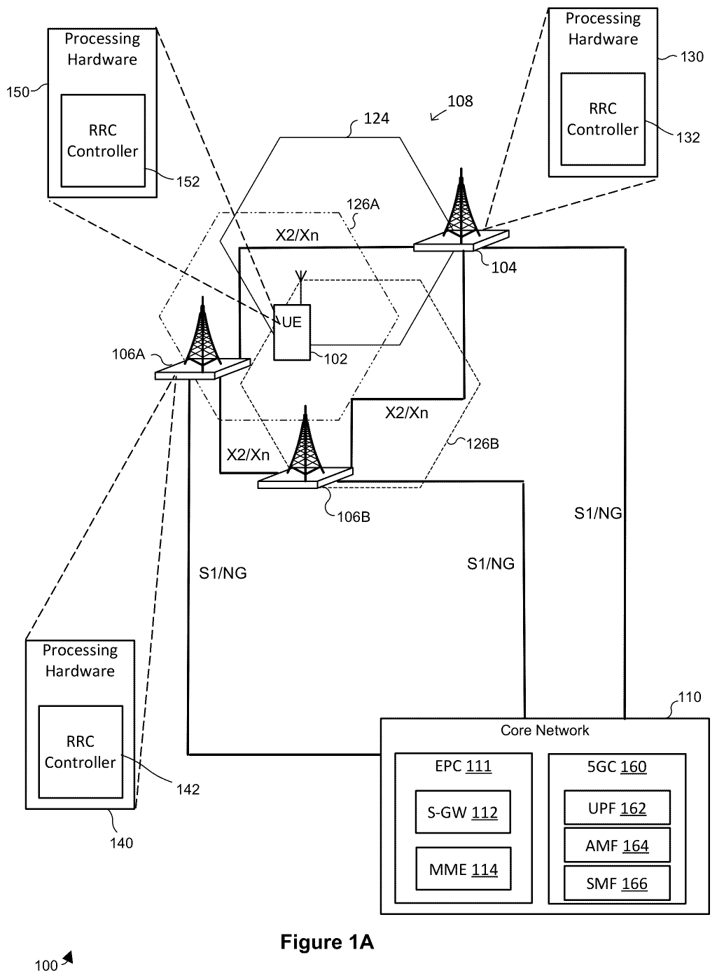

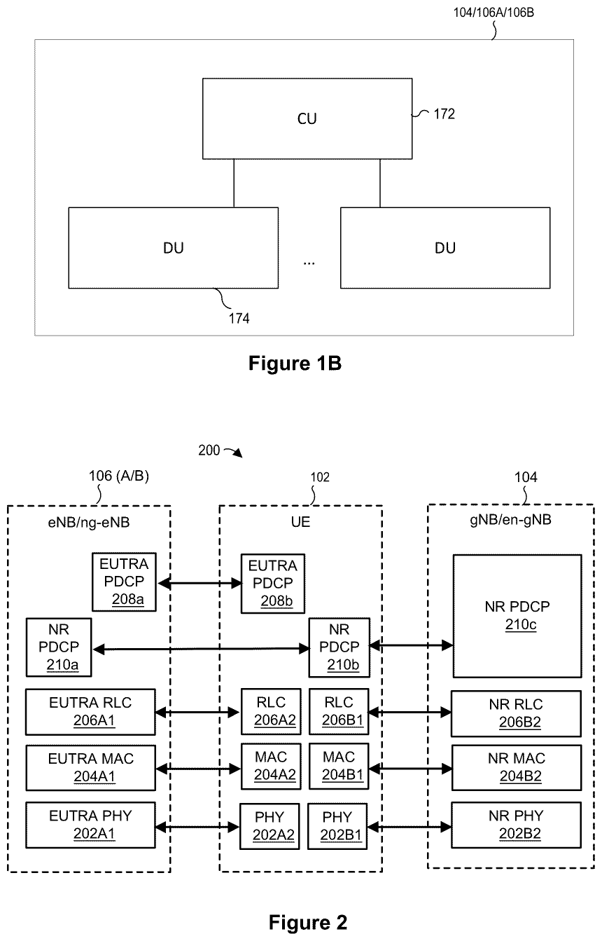

FIG. 1A depicts an example wireless communication system 100 that can implement dynamic UL band transmission techniques of this disclosure. The wireless communication system 100 includes a UE 102, as well as base stations 104, 106A, 106B that are connected to a core network (CN) 110. The base stations 104, 106A, 106B can include any suitable type, or types, of base stations, such as an evolved node B (eNB), a next-generation eNB (ng-eNB), or a 5G Node B (gNB), for example. As a more specific example, the base station 104 may be an eNB or a gNB, and the base station 106A and 106B may be gNBs.

The base station 104 supports a cell 124, the base station 106A supports a cell 126A, and the base station 106B supports a cell 126B. The base stations 104, 106A, 106B and their cells 124, 126A, 126B form at least a part of a RAN 108, with the RAN 108 collectively supporting communications with UEs using multiple, predefined operating bands (e.g., n5, n25, n95, etc.) that each support multiple frequency channels. The frequency channels in a given operating band may be fixed, or may be dynamically assigned or determined (e.g., with different center frequencies and/or different bandwidths at different times and/or for different UEs).

In the example shown, the cell 124 partially overlaps with both of cells 126A, 126B, such that the UE 102 can be in range to communicate with base stations 104, 106A, and 106B (or in range to detect or measure the signals from the base stations 104, 106A, and 106B, etc.). The overlap makes it possible for the UE 102 to hand over between cells (e.g., from cell 124 to cell 126A or 126B) before the UE 102 experiences radio link failure. Moreover, the overlap allows various dual connectivity (DC) scenarios. For example, the UE 102 can communicate in DC with the base station 104 (operating as a master node (MN)) and the base station 106A (operating as an secondary node (SN)) and, upon completing an SN change, can communicate with the base station 104 (operating as an MN) and the base station 106B (operating as an SN). As a more specific example, when the UE 102 is in DC with the base station 104 and 106A, the base station 104 may operate as a master eNB (MeNB), a master ng-eNB (Mng-eNB) or a master gNB (MgNB), and the base station 106A may operate as a secondary gNB (SgNB) or a secondary ng-eNB (Sng-eNB). In some implementations and scenarios where the UE 102 is in single connectivity (SC) with the base station 104 but is capable of operating in DC, the base station 104 may operate as an MeNB, an Mng-eNB or an MgNB, and the base station 106A may operate as a candidate SgNB (C-SgNB) or a candidate Sng-eNB (C-Sng-eNB). In some implementations any of the base stations 104, 106A, 106B generally can operate as an MN or an SN in different scenarios.

In operation, the UE 102 can use a radio bearer (e.g., a data radio bearer (DRB) or a signal radio bearer (SRB)) that at different times terminates at an MN (e.g., the base station 104) or an SN (e.g., the base station 106A). The UE 102 can apply one or more security keys when communicating on the radio bearer, in the UL (from the UE 102 to a base station) and/or DL (from a base station to the UE 102) direction.

The base station 104 includes processing hardware 130, which may include one or more general-purpose processors (e.g., central processing units (CPUs)) and a computer-readable memory storing machine-readable instructions executable on the general-purpose processor(s), and/or special-purpose processing units. The processing hardware 130 in the example implementation of FIG. 1A includes an RRC controller 132 that is configured to manage or control RRC procedures and RRC configurations. For example, the RRC controller 132 may be configured to support RRC messaging associated with handover procedures, and/or to support RRC messaging while the base station 104 operates as an MN or SN. The processing hardware 130 can also support network-side RACH procedures/messages.

The base station 106A includes processing hardware 140, which may include one or more general-purpose processors (e.g., CPUs) and a computer-readable memory storing machine-readable instructions executable on the general-purpose processor(s), and/or special-purpose processing units. The processing hardware 140 in the example implementation of FIG. 1A includes an RRC controller 142 that is configured to manage or control RRC procedures and RRC configurations. For example, the RRC controller 142 may be configured to support RRC messaging associated with handover procedures, and/or to support RRC messaging while the base station 106A operates as an SN or MN. The processing hardware 140 can also support network-side RACH procedures/messages. While not shown in FIG. 1A, the base station 106B may include processing hardware similar to the processing hardware 130 of the base station 104 and/or the processing hardware 140 of the base station 106A.

The UE 102 includes processing hardware 150, which may include one or more general-purpose processors (e.g., CPUs) and a computer-readable memory storing machine-readable instructions executable on the general-purpose processor(s), and/or special-purpose processing units. The processing hardware 150 in the example implementation of FIG. 1A includes an RRC controller 152 that is configured to manage or control RRC procedures and RRC configurations. For example, the RRC controller 152 (and/or another controller of the processing hardware 150) may be configured to support RRC messaging associated with handover procedures, and/or to support secondary node addition/modification procedures. The processing hardware 150 can also support UE-side RACH procedures/messages.

The CN 110 may be an evolved packet core (EPC) 111 or a fifth-generation core (5GC) 160, both of which are depicted in FIG. 1A. The base station 104 may be an eNB supporting an SI interface for communicating with the EPC 111, an ng-eNB supporting an NG interface for communicating with the 5GC 160, or a base station that supports the NR radio interface as well as an NG interface for communicating with the 5GC 160, for example. The base station 106A may be an en-gNB with an SI interface to the EPC 111, an en-gNB that does not connect to the EPC 111, a gNB that supports the NR radio interface as well as an NG interface to the 5GC 160, or an ng-eNB that supports an EUTRA radio interface as well as an NG interface to the 5GC 160, for example. To directly exchange messages with each other as may occur during certain scenarios discussed below, the base stations 104, 106A, 106B may support an X2 or Xn interface.

Among other components, the EPC 111 may include a Serving Gateway (S-GW) 112 and a Mobility Management Entity (MME) 114. The S-GW 112 is generally configured to transfer user-plane packets related to audio calls, video calls, Internet traffic, etc., and the MME 114 is generally configured to manage authentication, registration, paging, and other related functions. The 5GC 160 may include a User Plane Function (UPF) 162, an Access and Mobility Management Function (AMF) 164, and a Session Management Function (SMF) 166. The UPF 162 is generally configured to transfer user-plane packets related to audio calls, video calls, Internet traffic, etc., the AMF 164 is generally configured to manage authentication, registration, paging, and other related functions, and the SMF 166 is generally configured to manage PDU sessions.

Generally, the wireless communication system 100 may include any suitable number of base stations supporting NR cells and/or EUTRA cells, for example. More particularly, the EPC 111 or the 5GC 160 can be connected to any suitable number of base stations supporting NR cells and/or EUTRA cells. In general, the techniques of this disclosure can apply to other suitable radio access and/or core network technologies, such as sixth generation (6G) radio access and/or 6G core network or 5G NR-6G DC, for example.

The description herein at times refers to handovers and SN addition/change procedures. It is understood that the referenced handovers or SN addition/change procedures may be immediate or conditional procedures, and may be dual active protocol stack (DAPS) or non-DAPS procedures, unless a more specific meaning is apparent from the context in which the term is used.

As an example of an immediate, non-DAPS handover between cells in the wireless communication system 100, the base station 104 may perform a handover preparation procedure to configure the UE 102 to handover from the cell 124 of the base station 104 to the cell 126A of the base station 106A. In this scenario, the base station 104 and the base station 106A operate as a source base station (S-BS) or a source MN (S-MN), and a target base station (T-BS) or a target MN (T-MN), respectively. In the handover preparation, the S-BS (or S-MN) 104 sends a Handover Request message to the T-BS (or T-MN) 106A. In response, the T-BS (or T-MN) 106A includes a configuration (i.e., a set of configuration parameters) configuring radio resources for the UE 102 in a handover command message, and includes the handover command message in a Handover Request Acknowledge message. The T-BS (or T-MN) 106A sends the Handover Request Acknowledge message to the S-BS (or S-MN) 104. The S-BS (or S-MN) 104 then transmits the handover command message to the UE 102 and subsequently stops transmitting data to or receiving data from the UE 102. Upon receiving the handover command message, the UE 102 hands over to the T-BS (or T-MN) 106A via the cell 126A and communicates with the T-BS (or T-MN) 106A by using the parameters of the configuration in the handover command message. More specifically, in response to the handover command message, the UE 102 disconnects from the cell 124 (or the S-BS (or S-MN) 104), performs a random access procedure with the T-BS (or T-MN) 106A via the cell 126A, and then (after gaining access to a control channel) transmits a handover complete message to the T-BS (or T-MN) 106A via the cell 126A.

In some implementations, as discussed further below, the wireless communication system 100 supports UL-only and/or DL-only handover procedures. For example, the UE 102 may initially access the RAN 108 by establishing both a DL and a UL with the base station 104 in a first operating band (e.g., n95). At some time thereafter (e.g., in response to detecting a local event such as a desense or SAR compliance issue), the UE 102 can request a new UL band in a different operating band (e.g., request a lower-frequency operating band such as n5). If the RAN 108 approves the request, and if the base station 106A supports the requested UL band, the base station 104 can act as a S-BS and the base station 106A can act as a T-BS for purposes of a UL-only handover, while retaining the DL band for DL communications between the UE 102 and base station 104. Additionally or alternatively, in some implementations, the base station 104 can act as a S-BS and the base station 106A can act as a T-BS for purposes of a DL-only handover, while retaining the UL band for UL communications between the UE 102 and base station 104.

As an example of an immediate, non-DAPS SN addition procedure in the wireless communication system 100, after the UE 102 connects to the base station 104, the base station 104 can perform an SN addition procedure to add the base station 106A as an SN, thereby configuring the UE 102 to operate in DC with the base stations 104 and 106A. The base stations 104 and 106A can then operate as an MN and an SN, respectively. Later, the MN 104 may initiate a non-DAPS or DAPS handover preparation procedure to handover the UE 102 (or just the UL or just the DL of the UE 102) to a target MN (e.g., the base station 106B), for example.

As an example of an immediate, non-DAPS PSCell change (or PSCell change preparation) procedure in the wireless communication system 100, while the UE 102 is in DC with the MN 104 and the SN 106A, the MN 104 determines to change the SN of the UE 102 from the base station 106A (which may be referred to as the source SN, or S-SN) to the base station 106B (which may be referred to as the target SN, or T-SN) as part of the PSCell change procedure. After receiving the configuration for the T-PSCell 126B, the UE 102 stops communicating with the S-SN 106A via the PSCell 126A, and attempts to connect to the T-SN 106B via the T-PSCell 126B.

In some implementations, as discussed further below, the wireless communication system 100 supports UL-only and/or DL-only SN or PSCell addition or change procedures. For example, the UE 102 may initially access the RAN 108 by establishing both a DL and a UL with the base station 104 in a first operating band (e.g., n95). At some time thereafter (e.g., in response to detecting a local event such as a desense or SAR compliance issue), the UE 102 can request a new UL band in a different operating band (e.g., request a lower-frequency operating band such as n5). If the RAN 108 approves the request, and if the base station 106A supports the requested UL band, the RAN 108 may perform an SN addition procedure such that the UE 102 can then operate in DC with the base station 104 (for DL) and base station 106A (for UL).

In some configurations or scenarios of the wireless communication system 100, the base station 104 can operate as an MeNB, an Mng-eNB, or an MgNB and either or both of the base stations 106A, 106B can operate as an SgNB or an Sng-eNB. The UE 102 can communicate with the base station 104 and the base station 106A or 106B via the same RAT, such as EUTRA or NR, or via different RATs.

In some configurations or scenarios of the wireless communication system 100, the base station 104 may be an MeNB and the base station 106A may be an SgNB, and the UE 102 can be in EUTRA-NR DC (EN-DC) with the MeNB 104 and the SgNB 106A. When the base station 104 is an Mng-eNB and the base station 106A is an SgNB, the UE 102 can be in next generation (NG) EUTRA-NR DC (NGEN-DC) with the Mng-eNB 104 and the SgNB 106A. When the base station 104 is an MgNB and the base station 106A is an SgNB, the UE 102 can be in NR-NR DC (NR-DC) with the MgNB 104 and the SgNB 106A. When the base station 104 is an MgNB and the base station 106A is a Sng-eNB, the UE 102 can be in NR-EUTRA DC (NE-DC) with the MgNB 104 and the Sng-eNB 106A.

FIG. 1B depicts an example distributed implementation of a base station, such as the base station 104, 106A, or 106B of FIG. 1A. The base station in this implementation can include a centralized unit (CU) 172 and one or more distributed units (DUs) 174. The CU 172 is equipped with processing hardware that can include one or more general-purpose processors (e.g., CPUs) and non-transitory computer-readable memory storing machine-readable instructions executable on the one or more general-purpose processors, and/or special-purpose processing units. For example, the CU 172 may be equipped with the processing hardware 130 or the processing hardware 140. The DU 174 is likewise equipped with processing hardware that can include one or more general-purpose processors (e.g., CPUs) and non-transitory computer-readable memory storing machine-readable instructions executable on the one or more general-purpose processors, and/or special-purpose processing units. In some implementations, the processing hardware of the DU 174 includes a medium access control (MAC) controller configured to manage or control one or more MAC operations or procedures (e.g., a random access procedure) and a radio link control (RLC) controller configured to manage or control one or more RLC operations or procedures, e.g., when the base station operates as an MN, an SN or a C-SN. The processing hardware of the DU 174 may also include a PHY controller configured to manage or control one or more PHY layer operations or procedures.

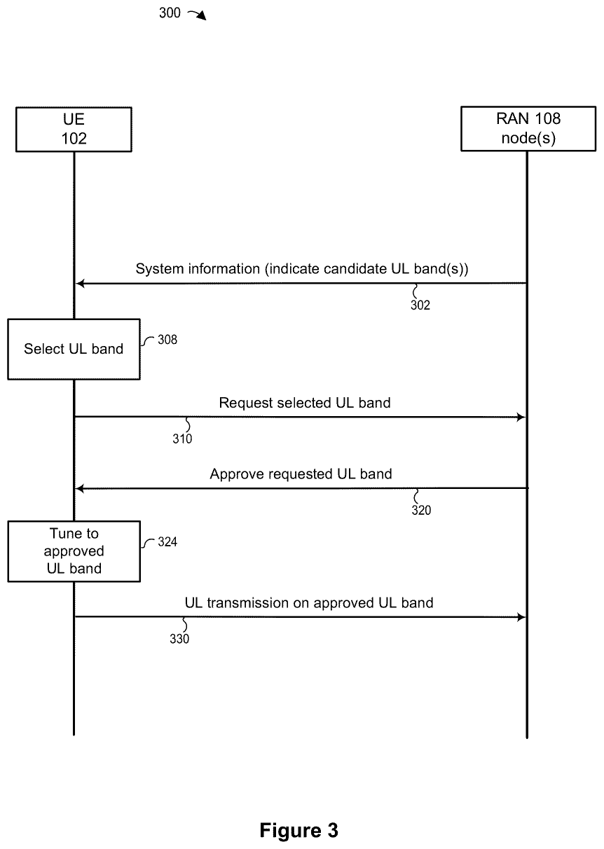

FIG. 2 illustrates, in a simplified manner, an example radio protocol stack 200 according to which the UE 102 may communicate with an eNB/ng-eNB or a gNB (e.g., one or more of the base stations 104, 106A, 106B, illustrated numerals for example only, e.g., the labeled 106A or 106B may, in other examples, be labeled 104, and vice versa).

In the example stack 200, a PHY 202A (202A1 and 202A2) of EUTRA provides transport channels to the EUTRA MAC sublayer 204A (204A1 and 204A2), which in turn provides logical channels to the EUTRA RLC sublayer 206A (206A1 and 206A2). The EUTRA RLC sublayer 206A in turn provides RLC channels to the EUTRA PDCP sublayer 208a and 208b and, in some cases, to the NR PDCP sublayer 210a, 210b, and 210c (collectively referred to as 210, other references likewise).

Similarly, the NR PHY 202B (202B1 and 202B2) provides transport channels to the NR MAC sublayer 204B (204B1 and 204B2), which in turn provides logical channels to the NR RLC sublayer 206B (206B1 and 206B2). The NR RLC sublayer 206B in turn provides RLC channels to the NR PDCP sublayer 210. The UE 102, in the implementation shown in FIG. 2, supports both the EUTRA and the NR stack in order to support handover between EUTRA and NR base stations, and/or to support DC over EUTRA and NR interfaces. Further, as illustrated in FIG. 2, the UE 102 can support layering of the NR PDCP sublayer 210 over the EUTRA RLC sublayer 206A.

The EUTRA PDCP sublayer 208 and the NR PDCP sublayer 210 receive packets (e.g., from an Internet Protocol (IP) layer, layered directly or indirectly over the PDCP layer 208 or 210) that can be referred to as service data units (SDUs), and output packets (e.g., to the RLC layer 206A or 206B) that can be referred to as protocol data units (PDUs). Where a “packet” or “data packet” is referred to herein, the packet may be an SDU or a PDU, for example.

On a control plane, the EUTRA PDCP sublayer 208 and the NR PDCP sublayer 210 can provide SRBs to exchange RRC messages, for example. On a user plane, the EUTRA PDCP sublayer 208 and the NR PDCP sublayer 210 can provide DRBs to support data exchange.

In scenarios where the UE 102 operates in EUTRA/NR DC (EN-DC), with the base station 104 operating as an MeNB and the base station 106A operating as an SgNB, the wireless communication system 100 can provide the UE 102 with an MN-terminated bearer that uses the EUTRA PDCP sublayer 208, or an MN-terminated bearer that uses the NR PDCP sublayer 210. The wireless communication system 100 in various scenarios can also provide the UE 102 with an SN-terminated bearer, which uses only the NR PDCP sublayer 210. The MN-terminated bearer can be an MCG bearer, an SCG bearer, or a split bearer. The SN-terminated bearer can be, an MCG bearer, an SCG bearer, or a split bearer. The MN-terminated bearer can be an SRB (e.g., SRB1 or SRB2) or a DRB. The SN-terminated bearer can be an SRB or a DRB.

The base stations 104, 106A, 106B generally support UL and DL communications with UEs such as the UE 102. In some implementations, one or more of the base stations 104, 106A, 106B each supports at least one conventionally-paired/coupled UL and DL (e.g., in an FDD operating band such as n74, such that the UL and DL use different frequencies within the operating band, or in a TDD operating band such as n79, such that the UL and DL use the same frequency within the operating band). In other implementations, none of the base stations 104, 106A, 106B supports a conventionally-paired/coupled UL and DL. In either case, however, the RAN 108 supports decoupled UL/DL operation. For decoupled UL/DL operation, a node of the RAN 108 (e.g., the base station 104) can inform a UE (e.g., the UE 102) of available/candidate UL bands, including (in at least some scenarios) multiple candidate UL bands that are outside of the operating band being used for DL communications from the node of the RAN 108 to the UE. The UE can then select and request a preferred or desired UL band from among the candidate UL bands, and the RAN 108 may approve or deny the request. The DL may be between the UE and a first RAN node (e.g., base station 104) while the decoupled UL is between the UE and a different, second RAN node (e.g., base station 106A), e.g., in carrier aggregation or DC scenarios. In other implementation and/or scenarios, the decoupled DL and UL may both be between a UE and a single RAN node (e.g., base station 104) configured to operate in different operating bands.

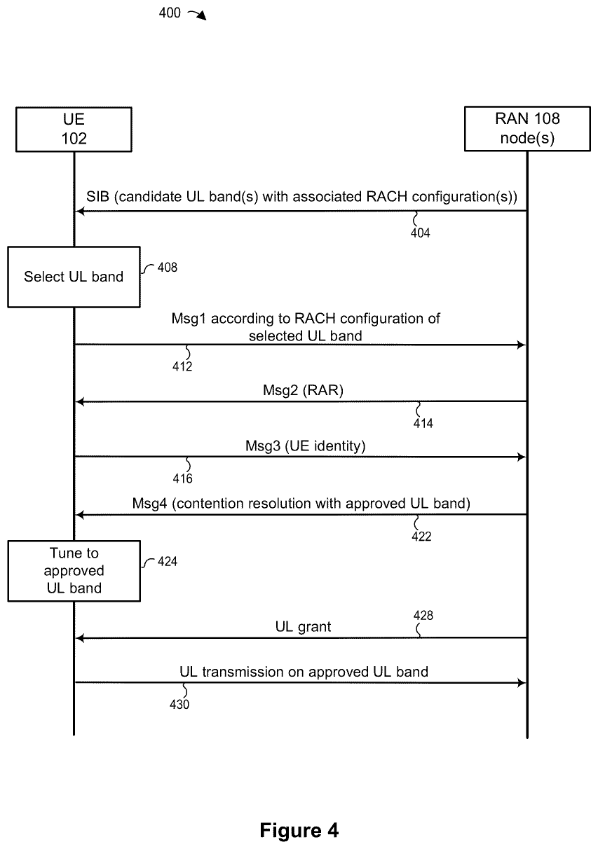

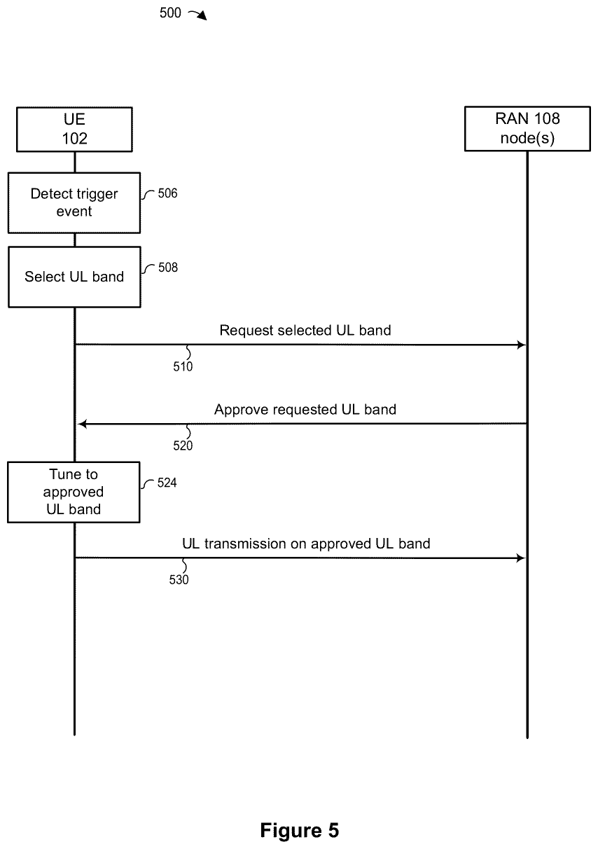

Dynamic UL band transmission will now be described in further detail with reference to the messaging diagrams of FIGS. 3-6. In particular, FIGS. 3 and 4 show example implementations and scenarios in which, upon initial access, the UE 102 selects a decoupled UL band for communication with the RAN 108, while FIGS. 5 and 6 show example implementations and scenarios in which, after the UE 102 communicates with the RAN 108 using a first UL band (which may or may not be in the same operating band as the DL band), the UE 102 selects a new, decoupled UL band for communication with the RAN 108. In general, events in FIGS. 3-6 that may be similar are labeled with similar reference numbers (e.g., events 308 may be similar to event 408, 508, and 608), with differences discussed below where appropriate. With the exception of the differences shown in the figures and discussed below, any of the alternative implementations discussed with respect to a particular event (e.g., for messaging and processing) may apply to events labeled with similar reference numbers in other figures. While the below description of FIGS. 3-6 refers to specific components of the wireless communication system 100 (e.g., UE 102A and base station 104), the operations may instead be performed by components other than those shown in FIG. 1A.

FIG. 3 shows a scenario 300 in which the UE 102 gains initial access to the RAN 108 via a first RAN node of the RAN 108 (e.g., via the base station 104, or via a DU 174 of the base station 104). In the scenario 300, the first RAN node transmits 302 system information to the UE 102. The first RAN node may transmit 302 the system information by broadcasting the system information (e.g., in a SIB) to multiple UEs including the UE 102, for example. The system information indicates a number of candidate UL bands. For example, the system information may include a list of bands from which the UE 102 may select a preferred UL band. Depending on the scenario, in some implementations, the indicated candidate UL band(s) may include only one band or include multiple bands. In some implementations, as discussed further below with reference to FIG. 4, the system information transmitted 302 by the first RAN node also includes a respective RACH configuration for each candidate UL band. For example, each candidate UL band may correspond to a different RACH configuration (i.e., a configuration specifying different RACH resources, such as different PRACH time and/or frequency resources, and/or different preamble sequences).

The first RAN node also provides signals/information that allow the UE 102 to receive communications from the first RAN node on a DL band. For example, the first RAN node may broadcast a synchronization signal block (SSB), which allows the UE 102 to detect a system information block (SIB) associated with a particular DL band (e.g., the same SIB that includes the system information of event 302 or a SIB that provides information to support UE access to another SIB that includes the system information of event 302). In at least some scenarios, the candidate UL band(s) indicated at event 302 by the first RAN node include multiple bands that are outside of the operating band used for DL communications from the first RAN node to the UE 102. The DL band may act as an “anchor” frequency band for any UL band(s) selected by the UE 102, for example, and the DL band may or may not also be paired with a UL band in a conventional sense (i.e., paired with a UL band in the same operational band as the DL band).

After receiving the system information at event 302, the UE 102 selects 308 a UL band from among the candidate UL band(s). The UE 102 may select 308 the particular UL band for any of various reasons, depending on the implementation and/or scenario. For example, the UE 102 may autonomously select 308 the UL band based on capabilities, priorities, and/or preferences of the UE 102. In some implementations and/or scenarios, the UE 102 might prefer UL bands that are lower in frequency than the DL band, e.g., to facilitate compliance with SAR/power level requirements. The UL band selected 308 by the UE 102 may be in an operating band that is designated as having the same type of duplex as the operating band of the DL (e.g., both TDD or both FDD), or an operating band that is designated as having a different type of duplex than the operating band of the DL (e.g., the n7 FDD band for the UL and the n40 TDD band for the DL, or vice versa).

After selecting 308 the UL band, the UE 102 transmits 310 a request for the selected UL band to the RAN 108. In some implementations, event 310 includes the UE 102 transmitting a RACH message using a configuration corresponding to the selected UL band (e.g., as discussed in further detail below with reference to FIG. 4). In other implementations, event 310 includes the UE 102 transmitting a different message indicating the selection, such as an RRC message (e.g., a dedicated RRC message).

After receiving the request at event 310, the first RAN node, or a different, second node of the RAN 108 (e.g., a different DU 174 of the base station 104, a different base station such as base station 106A, or a DU 174 of a different base station such as base station 106A), determines whether to approve the request. That is, the first or second RAN node determines whether to approve the use, by the UE 102, of the requested UL band for UL communications. The scenario 300 shown in FIG. 3 is one in which the RAN 108 (i.e., the first or second RAN node) decides to approve the requested UL band, and therefore transmits 320 an indication that the requested UL band is approved. In some implementations, the approval at event 320 is implicitly indicated via a RACH message (e.g., as discussed below with reference to FIG. 4). In other implementations, the message transmitted at event 320 is an RRC message (e.g., with both event 310 and event 320 corresponding to transmissions of respective RRC messages).

The message including the approval at event 320 may include UL configuration information for the UL band. For example, the approval may include numerology (e.g., sub-carrier spacing or channel bandwidth) that the UE 102 should use for UL communications via the UL band, and/or other UL configuration information (e.g., TDD UL configuration information).

In an alternative scenario, not represented in FIG. 3, the first or second RAN node instead decides not to approve the requested UL band, and event 320 therefore does not occur. In this case, the first or second RAN 108 node may respond with a rejection message instead of event 320. The UE 102 may then select and request another UL band from the candidate UL bands, by repeating events similar to events 308 and 310. In other implementations and/or scenarios, when the first or second RAN node decides not to approve the requested UL band, the first or second RAN node can decide to use another, second UL band, and will then transmit an indication of that second UL band to the UE 102 instead of event 320. Depending on the implementation, the UE 102 may be required to use the second UL band, or may have the option of attempting to select and request another, third UL band by repeating events similar to events 308 and 310.

Returning now to the scenario 300 depicted in FIG. 3, after receiving the approval at event 320, the UE 102 tunes 324 its receiver to the approved UL band and transmits 330 UL data and/or control information via the approved UL band. In some implementations and/or scenarios, the transmission 330 (e.g., UL data transmission) only occurs when the RAN 108 (e.g., the first or second RAN node) grants a UL data transmission (e.g., via a dynamic or configured grant).

In some implementations, the UE 102 sends the RAN 108 (e.g., the first RAN node discussed above) a UE capability message (e.g., an RRC message) indicating that the UE 102 is capable of supporting decoupled DL and UL bands (i.e., indicating that the UE 102 can support the UL band independently of the DL band). In some implementations, the UE capability message lists or otherwise indicates specific UL/DL band pairs that the UE 102 is capable of supporting. In alternative scenarios where the RAN 108 denies the requested UL band, the first or second RAN node may choose a different UL band from among the UL bands indicated in the UE capability information (e.g., a UL band of a specific UL/DL band pair, where that UL/DL band pair specifies the DL band associated with the first or second RAN node).

FIG. 4 depicts messaging in a specific implementation of the technique shown in FIG. 3. In FIG. 4, in a scenario 400, the UE 102 gains initial access to the RAN 108 via a first RAN node of the RAN 108 (e.g., via the base station 104, or via a DU 174 of the base station 104). The first RAN node transmits 404 to the UE 102 (i.e., in this example, broadcasts to one or more UEs including UE 102) a SIB containing system information. The system information includes an indication of one or more candidate UL bands and associated RACH configurations (e.g., a different RACH configuration for each candidate UL band). Each RACH configuration may specify different RACH resources (e.g., different PRACH time and/or frequency resources, and/or different preamble sequences). The SIB is associated with a particular DL band supported by the first RAN node (e.g., n66, or a band within n66), and some or all of the candidate UL band(s) may be in a different operating band than the DL band (e.g., with candidate UL bands in n2 and/or n71, and possibly also in n66). In at least some scenarios, the SIB indicates multiple candidate UL bands that are outside of the operating band used by the first RAN node for DL communications.

The first RAN node may also (e.g., prior to event 404) broadcast an SSB, which allows the UE 102 to detect the SIB at event 404. The first RAN node may transmit the SIB of event 404 with low periodicity (e.g., with lower periodicity than one or more other SIBs that provide DL information but do not indicate candidate UL bands) in order to reduce system overhead. In some implementations, the first RAN node broadcasts a first type of SIB for DL-only information, a second type of SIB for providing candidate UL band information, and a third type of SIB for legacy, conventionally-paired UL/DL information.

The UE 102 may select 408 a preferred or desired UL band from among the candidate UL band(s), e.g., as discussed above with reference to event 308. In the example implementation of FIG. 4, the UE 102 then requests the selected UL band by initiating a RACH procedure. In particular, the UE 102 requests the selected UL band by transmitting 412 to the first RAN node, or to a second RAN node (e.g., a different DU 174 of the base station 104, a different base station such as base station 106A, or a DU 174 of a different base station such as base station 106A), a Msg1 using the RACH configuration (as indicated in the SIB of event 404) corresponding to the selected UL band. That is, the Msg1 may be sent using a PRACH specific to the selected UL band, and/or may contain a preamble specific to the selected UL band. In alternative implementations, such as a two-step RACH procedure, a MsgA explicitly indicates the selected UL band and the UE identity (and does not send a Msg3).

After receiving the Msg1 at event 412, the first or second RAN node transmits 414 a Msg2 random access response (RAR) back to the UE 102, and the UE 102 then transmits 416 a Msg3 containing its UE identity to the first or second RAN node. The first or second RAN node then transmits 422 a Msg4 to the UE 102. The Msg4 indicates contention resolution with an approval of the selected/requested UL band. In other implementations, such as a two-step RACH procedure, the first or second RAN node includes the approval of the selected/requested UL band in a MsgB sent at event 414 (and does not send a Msg4).

In an alternative scenario, not represented in FIG. 4, the first or second RAN node decides not to approve the requested UL band, and the RACH procedure initiated at event 412 therefore fails (e.g., event 422 does not occur, or does not indicate an approval). The UE 102 may then select and request another UL band from the candidate UL bands, by repeating events similar to events 408 and 412. In other implementations and/or scenarios, when the first or second RAN node decides not to approve the requested UL band, the first or second RAN node decides to use another, second UL band, and transmits an indication of that second UL band to the UE 102 at event 422 (or 414 in a two-step RACH procedure). Depending on the implementation, the UE 102 may be required to use the second UL band, or may have the option of attempting to select and request another, third UL band by repeating events similar to events 408 and 412.

Returning now to the scenario 400 depicted in FIG. 4, after the approval of event 422, the UE 102 tunes 424 its receiver to the approved UL band (e.g., similar to event 324). At some later time, in the example scenario 400, the RAN 108 (e.g., the first RAN node) transmits 428 a UL grant to the UE 102. In some implementations and/or scenarios, the first RAN node can transmit 428 to the UE 102 a single DL channel information (DCI), on a physical downlink control channel (PDCCH) in the DL band, that indicates the grant for both DL data and UL data using different operating bands of the UE 102 operating in MR-DC. In other implementations and/or scenarios, the first RAN node transmits 428, using the PDCCH in the DL operating band, only a grant for UL data to be transmitted in the non-overlapping UL operating band, and separately transmits a grant, using the PDCCH in the DL operating band, for DL data to be transmitted in the DL operating band. In response to event 428, the UE 102 transmits 430 on the UL (e.g., transmits UL data packets) using the approved UL band.

In some implementations, the SIB transmitted by the first RAN node at event 404 includes one or more UL RACH power control parameters, such as offsets of the UL PRACH path loss in the UL band with respect to the DL path loss in the DL band (e.g., one such offset for each candidate UL band identified in the SIB). More generally, the system information transmitted by the first RAN node at event 302 may contain this information.

In some implementations, the RAN 108 (e.g., the first or second RAN node) can use one or more dedicated RRC messages, instead of or in addition to the system information of event 302 or 404, to indicate the candidate UL bands and/or the corresponding RACH configurations to the UE 102. In some implementations, for example, the RAN 108 provides the information via RRC messaging when carrying out a handover, carrier aggregation (CA), or dual connectivity (DC) procedure. For example, the RAN 108 may provide the information via an RRC message to initiate or support a UL-only handover (discussed further below) of the UE 102 to another RAN node.

In some implementations, for the scenario 300 or the scenario 400, the UE 102 transmits only a single UL channel information (UCI), on a physical uplink control channel (PUCCH) or physical uplink shared channel (PUSCH) in the approved UL band, to provide scheduling request (SR), hybrid automatic repeat request (HARQ), and/or channel state information (CSI) feedback to the RAN 108.

FIGS. 5 and 6 correspond to scenarios after the UE 102 has already accessed the RAN 108 (e.g., via the “first RAN node” discussed above with reference to FIGS. 3 and 4), and desires to change to a new UL band (i.e., change to a new DL/UL pairing, but with the DL band remaining unchanged). For example, FIGS. 5 and/or 6 may depict a scenario that occurs after the scenario 300 and/or 400, respectively, has already occurred. Alternatively, the UE may have a conventional UL/DL TDD pairing and seek to separate the UL and DL data signaling into different operating bands.

Referring first to the scenario 500 of FIG. 5, the UE 102 at some point in time detects 506 a trigger event. The triggering event may be a condition or circumstance that creates a desense problem (e.g., detecting interference on the current UL band above a threshold level) or a transmission power problem (e.g., the current UL band requiring a large power backoff due to SAR constraints). Based on (e.g., in response to) the detection 506, the UE 102 selects 508 a new UL band. The UE 102 may make the selection from among candidate UL bands that were indicated by the RAN 108 in system information (e.g., by the first RAN node at event 302 or 404), and/or from among candidate UL bands that were indicated by the RAN 108 in one or more dedicated RRC messages after initial access, for example.

After event 508, the UE 102 transmits 510 a request for the selected UL band to the RAN 108. The UE 102 transmits 510 the request to the first RAN node that currently provides the DL (e.g., the base station 104 or a DU 174 thereof). The request may be made as a part of a RACH procedure (e.g., as discussed below with reference to FIG. 6), or via dedicated RRC messaging, for example.

The first or second RAN node that received the request at event 510 can then transmit 520 to the UE 102 a message indicating approval of the requested UL band. In the depicted scenario 500, after receiving the approval at event 520, the UE 102 tunes 524 its receiver to the approved UL band, and transmits 530 UL data and/or control information via the approved UL band. In some implementations and/or scenarios, the transmission 530 (e.g., UL data transmission) only occurs when the RAN 108 (e.g., the first or second RAN node) grants a UL data transmission (e.g., via a dynamic or configured grant).

In an alternative scenario, not represented in FIG. 5, the first or second RAN node instead decides not to approve the requested UL band, and event 520 does not occur. Instead, the RAN 108 node transmits a rejection message or no response to the request. The UE 102 may then select and request another UL band from the candidate UL bands, by repeating events similar to events 508 and 510. In other implementations and/or scenarios, when the first or second RAN node decides not to approve the requested UL band, the first or second RAN node decides to use another, second UL band, and transmits an indication of that second UL band to the UE 102 in place of event 520. Depending on the implementation, the UE 102 may be required to use the second UL band, or may have the option of attempting to select and request another, third UL band by repeating events similar to events 308 and 310.

FIG. 6 depicts messaging in a specific implementation of the technique shown in FIG. 5. In the scenario 600 of FIG. 6, the UE 102 at some point in time detects 606 a trigger event (e.g., similar to event 506). Based on (e.g., in response to) the detection 606, the UE 102 selects 608 at least one new UL band from among the candidate UL bands (e.g., similar to event 508), with each of some or all of the candidate UL bands being outside of the operating band the first RAN node and UE 102 use for the DL. The UE 102 requests the selected UL band by transmitting 613 to the first RAN node an RRC message. The RRC message may explicitly indicate the new (selected) UL band, or only implicitly indicate the new UL band. For example, the RRC message may be an RRC message providing updated or augmented UE capability information for the UE 102, with the capability information indicating a new UL band preference of the UE 102.

After receiving the RRC message at event 613, the first or second RAN node transmits 623 to the UE 102 an RRC message that approves the requested UL band, and includes a RACH configuration (e.g., a particular PRACH and/or preamble sequence) associated with the requested UL band. Later (e.g., in response to event 623), the UL tunes 624 its receiver to the approved UL band.

At some later point in time, the UE 102 decides to transmit UL data, and in response transmits 625 a first message of a RACH procedure (in the depicted example, a MsgA of a 2-step RACH procedure) to the first or second RAN node, using the approved UL band and the corresponding RACH configuration. After receiving the MsgA at event 625, the first or second RAN node transmits 627 a MsgB (including timing advance information) back to the UE 102 on the approved UL band. In some implementations, the UE 102 and RAN 108 use a 4-step RACH procedure to rather than the 2-step RACH procedure shown in FIG. 6.

After event 627, in the scenario 600 of FIG. 6, the first or second RAN node transmits 628 a UL grant to the UE 102 (e.g., similar to event 428), and in response the UE 102 transmits 630 (e.g., transmits UL data packets) in accordance with the UL grant using the approved UL band.

In some implementations and/or scenarios, the first RAN node also transmits one or more DL messages to the UE 102 using the DL band, with the DL message(s) including control information for the UL communications in the approved UL band. The control information can include one or more power control parameters for the UL, one or more timing control parameters for the UL, dynamic grant information for the UL, or configured grant information for the UL, for example.

In some implementations, for the scenario 500 or the scenario 600, the UE 102 transmits only a single UCI, on a PUCCH (or possibly PUSCH) in the approved UL band, to provide a SR, HARQ, and/or CSI feedback to the RAN 108.

In some implementations, the RAN 108 supports dynamic slot configuration in order to provide half-duplex operation. For example, the first RAN node can use the DL band to send the UE 108 control information, in order to schedule DL reception by the UE 102 and UL transmission by the UE 102 to occur during different time slots (in addition to those DL and UL communications being in different frequencies of different operating bands). The scheduling by the first RAN node may provide or allow for a suitable guard period between the DL reception and UL transmission by the UE 102 in different operating bands, to allow the UE 102 time to switch from DL to UL frequencies. For example, the RAN 108 may use a special subframe that includes such a guard period. Such a guard period may be required due to UEs (e.g., the UE 102) being unable to perform baseband processing for the DL and UL simultaneously, even in implementations where the radio frequency (RF) chains used by the UE 102 for UL and DL communications are independent of (not connected to) each other.

As noted above, in some implementations, the wireless communication system 100 can support UL-only and/or DL-only handovers (e.g., such that DL handover is independent from UL handover, in at least some scenarios) after initial access by a UE (e.g., UE 102). For example, the first or second RAN node discussed above with reference to the messaging diagrams of FIGS. 3-6 may handover the UL of the UE 102 to a different band, frequency, and/or cell (e.g., from cell 126B of base station 106B to cell 126A of base station 106A), while the DL band and cell remain unchanged for the UE 102 (e.g., cell 124 of base station 104). That is, the UL-only handover transitions the UE 102 from (1) communicating bi-directionally with the RAN 108 using a first UL band for UL communications from the UE 102 to the RAN 108 (e.g., to the second RAN node) and the DL band for DL communications from the RAN 108 (e.g., from the first RAN node) to the UE 102, to (2) communicating bi-directionally with the RAN 108 using a second UL band for UL communications from the UE 102 to the RAN 108 (e.g., to a third RAN node) and the same DL band for DL communications from the RAN 108 (e.g., from the first RAN node) to the UE 102. In other implementations and/or scenarios, the first RAN node discussed above with reference to the messaging diagrams of FIGS. 3-6 may handover the DL of the UE 102 to a different band, frequency, and/or cell (e.g., from cell 124 of base station 104 to cell 126A of base station 106A), while the UL band and cell remain unchanged for the UE 102 (e.g., cell 126B of base station 106B, or cell 124).

RRC messaging can be used by the source and target node of the RAN 108 to independently perform DL and/or UL handovers. In some implementations, the RRC messaging of the handover includes an RRC message, transmitted from the source node (e.g., base station 104) to the UE 102, indicating whether the handover is UL-only (or DL-only, in other implementations and/or scenarios). The indication may be a binary (e.g., yes/no) indication or a flag (e.g., presence/absence), for example.

In some implementations, the RAN 108 provides the UE 102 a measurement gap in which to measure, in a particular band that the UE 102 is not currently using, a DL signal transmitted by a node of the RAN 108 (e.g., the first RAN node discussed above, such as base station 104). In some implementations, the UE 102 measures the DL signal in the same band the UE 102 prefers to use for the UL. For example, the UE 102 may measure a DL signal in the FDD band n71 when the UE 102 prefers to use the n71 band for UL communications.

The UE 102 measures the DL signal and, leveraging the principle of antenna reciprocity, uses the measurement for UL band selection or reselection. The node of the RAN 108 may transmit to the UE 102 a UL band configuration that the UE 102 can use to make the measurement during the measurement gap. The first RAN node may determine the UL band configuration based on capabilities of the UE 102, e.g., as indicated by UE capability information that the UE 102 earlier sent to a node of the RAN 108. In some implementations, a node of the RAN 108 (e.g., the first RAN node discussed above, such as the base station 104) can transmit to the UE 102 a message that configures the UE 102 to transmit a sounding reference signal (SRS) in the preferred UL band during a measurement gap for a UL-only handover. The RAN node may transmit the message in response to information in a UE capability message that the RAN node received from the UE 102, for example, with the UE capability message indicating that the UE 102 can use the DL band for DL communications while using the UL band for UL communications.

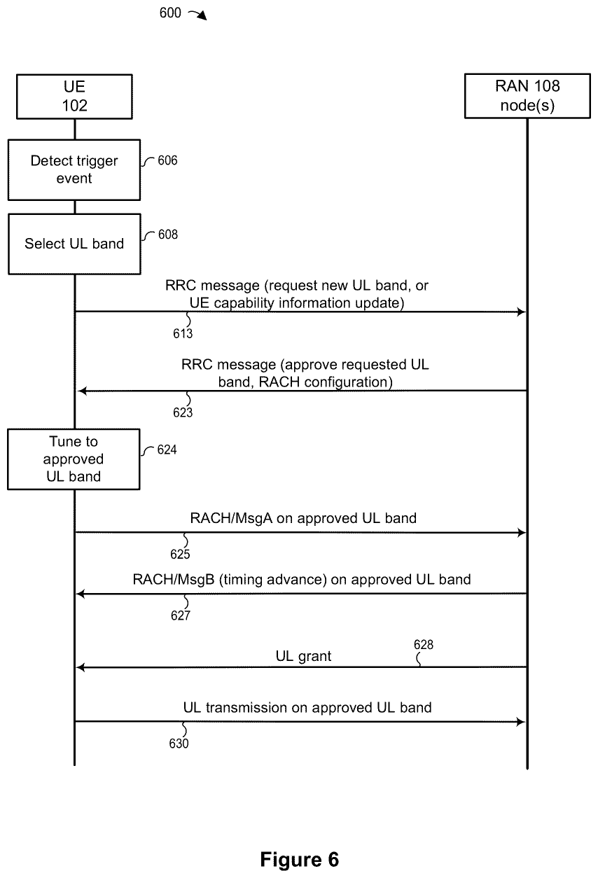

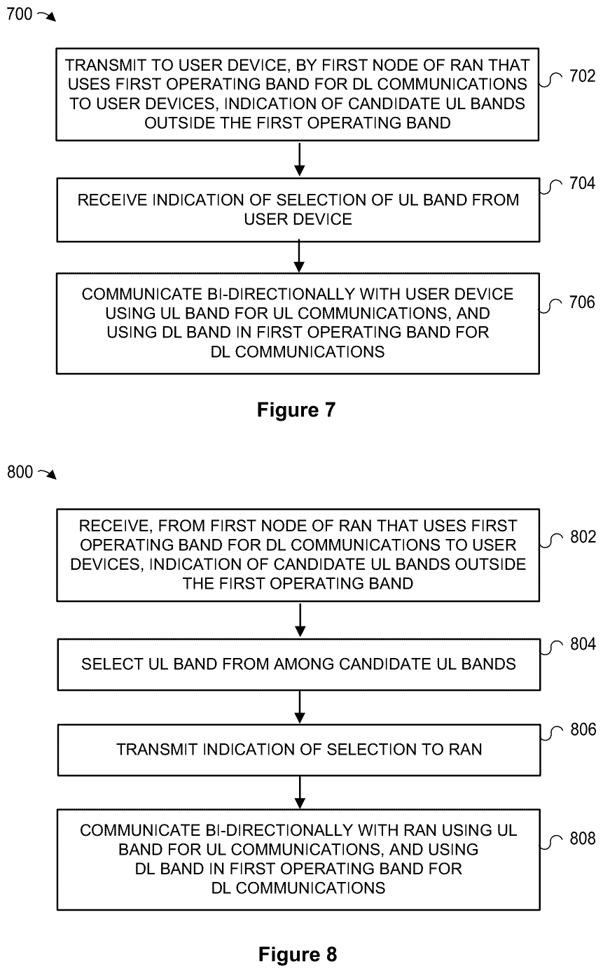

FIGS. 7 and 8 are flow diagrams of example methods for dynamic UL band transmission, from the perspective of one or more nodes of a RAN (e.g., the RAN 108) and the perspective of a user device (e.g., the UE 102), respectively.

Referring first to FIG. 7, in an example method 700, a first node of the RAN transmits to the user device (e.g., event 302 or 404) an indication of two or more candidate UL bands (block 702). Depending on the implementation, the first node might indicate only one or zero candidate UL bands in other scenarios, or the first node might indicate multiple candidate UL bands in all scenarios. The first node (e.g., the base station 104, or a DU 174 of the base station 104) uses a first operating band (e.g., n5, or n71, etc.) for DL communications to user devices (e.g., to UEs within the cell 124), and each of the indicated candidate UL bands is outside of that first operating band. In some implementations, however, the first node may additionally indicate a candidate UL band that is in the first operating band (i.e., such that, instead of selecting any of the two or more UL bands outside the first operating band used, the user device can optionally decide to select a candidate UL band in the same operating band as the DL band).

The first node, or a second node of the RAN (e.g., the base station 106A, or a different DU 174 of the base station 104), receives from the user device (e.g., event 310, 412, 510, or 613) an indication of a selection of a UL band from among the indicated candidate UL bands (block 704). In some scenarios, the selected UL band is lower in frequency than the DL band used by (or to be used by) the first node of the RAN for DL communications with the user device. Collectively, the RAN node(s) (e.g., the first node that performed block 702, and also the second node if a second node performed block 704) then communicate bi-directionally with the user device (e.g., event 330, 430, 530, or 630, in addition to DL transmissions not shown in FIGS. 3-6) using the UL band for UL communications from the user device to the RAN, and using the DL band for DL communications from the RAN to the user device. The UL and DL communications may be separated only in frequency, or in both time and frequency (i.e., half-duplex operation).

Referring next to FIG. 8, in an example method 800, a user device (e.g., the UE 102) receives from a first node of a RAN (e.g., event 302 or 404) an indication of two or more candidate UL bands (block 802). Depending on the implementation, the first node might indicate only one or zero candidate UL bands in other scenarios, or the first node might indicate multiple candidate UL bands in all scenarios. The first node (e.g., the base station 104, or a DU 174 of the base station 104) uses a first operating band (e.g., n5, or n71, etc.) for DL communications to user devices (e.g., to UEs within the cell 124), and each of the indicated candidate UL bands is outside of that first operating band. In some implementations, however, the first node may additionally indicate a candidate UL band that is in the first operating band (i.e., such that, instead of selecting any of the two or more UL bands outside the first operating band used, the user device can optionally decide to select a candidate UL band in the same operating band as the DL band).

The user device later selects (e.g., event 308, 408, 508, or 608) a UL band from among the indicated candidate UL bands (block 804), and transmits (e.g., event 310, 412, 510, or 613) an indication of the selection of the UL band to either the first node or a second node of the RAN (e.g., the base station 106A, or a different DU 174 of the base station 104) (block 806). In some scenarios, the user device selects a UL band that is lower in frequency than the DL band used by (or to be used by) the first node of the RAN for DL communications with the user device. The user device then communicates bi-directionally with the RAN node(s) (e.g., event 330, 430, 530, or 630, in addition to DL transmissions not shown in FIGS. 3-6) using the UL band outside the first operating band for UL communications from the user device to the RAN, and using the DL band in the first operating band for DL communications from the RAN to the user device. The UL and DL communications may be separated only in frequency, or in both time and frequency (i.e., half-duplex operation).

The following additional considerations apply to the foregoing discussion.

A user device in which the techniques of this disclosure can be implemented (e.g., the UE 102) can be any suitable device capable of wireless communications such as a smartphone, a tablet computer, a laptop computer, a mobile gaming console, a point-of-sale (POS) terminal, a health monitoring device, a drone, a camera, a media-streaming dongle or another personal media device, a wearable device such as a smartwatch, a wireless hotspot, a femtocell, or a broadband router. Further, the user device in some cases may be embedded in an electronic system such as the head unit of a vehicle or an advanced driver assistance system (ADAS). Still further, the user device can operate as an internet-of-things (IoT) device or a mobile-internet device (MID). Depending on the type, the user device can include one or more general-purpose processors, a computer-readable memory, a user interface, one or more network interfaces, one or more sensors, etc.

Certain embodiments are described in this disclosure as including logic or a number of components or modules. Modules may can be software modules (e.g., code stored on non-transitory machine-readable medium) or hardware modules. A hardware module is a tangible unit capable of performing certain operations and may be configured or arranged in a certain manner. A hardware module can include dedicated circuitry or logic that is permanently configured (e.g., as a special-purpose processor, such as a field programmable gate array (FPGA) or an application-specific integrated circuit (ASIC)) to perform certain operations. A hardware module may also include programmable logic or circuitry (e.g., as encompassed within a general-purpose processor or other programmable processor) that is temporarily configured by software to perform certain operations. The decision to implement a hardware module in dedicated and permanently configured circuitry, or in temporarily configured circuitry (e.g., configured by software) may be driven by cost and time considerations.

When implemented in software, the techniques can be provided as part of the operating system, a library used by multiple applications, a particular software application, etc. The software can be executed by one or more general-purpose processors or one or more special-purpose processors.

Upon reading this disclosure, those of skill in the art will appreciate still additional alternative structural and functional designs for dynamic UL band transmission through the disclosed examples and principles herein (see Examples below). Thus, while particular embodiments and applications have been illustrated and described, it is to be understood that the disclosed embodiments are not limited to the precise construction and components disclosed herein. Various modifications, changes and variations, which will be apparent to those of ordinary skill in the art, may be made in the arrangement, operation and details of the method and apparatus disclosed herein without departing from the spirit and scope defined in the appended claims.

### Examples

Example 1. A method implemented by one or more nodes of a radio access network (RAN) that supports communications with user devices using a plurality of operating bands each supporting a plurality of frequency channels, the method comprising:
transmitting, by a first node of the one or more nodes and to a user device, an indication of two or more candidate uplink (UL) bands, the first node using a first operating band for downlink (DL) communications to user devices, and each of the two or more candidate UL bands being outside of the first operating band;
receiving, by processing hardware of the one or more nodes and from the user device, an indication of a selection, from among the two or more candidate UL bands, of a UL band for UL communications from the user device to the RAN; and
communicating, by the processing hardware, bi-directionally with the user device (i) using the UL band for the UL communications from the user device to the RAN and (ii) using a DL band in the first operating band for DL communications from the RAN to the user device.
Example 2. The method of Example 1, wherein receiving the indication of the selection of the UL band from the user device includes receiving from the user device a random access channel (RACH) procedure message that is sent by the user device using a RACH configuration that corresponds to the UL band.
Example 3. The method of Example 2, further comprising:
after receiving the indication of the selection of the UL band, transmitting, by the processing hardware, a later RACH procedure message to the user device, wherein the later RACH procedure message approves the UL band for the UL communications.
Example 4. The method of Example 3, wherein the later RACH procedure message includes one or more parameters for the user device to use for the UL communications, the one or more parameters including:
a sub-carrier spacing; and/or
one or more time division duplexing (TDD) configuration parameters.
Example 5. The method of any one of Examples 1-4, wherein transmitting the indication of the two or more candidate UL bands includes broadcasting system information including the indication of the two or more candidate UL bands.
Example 6. The method of Example 5, wherein:
the system information includes two or more random access channel (RACH) configurations each corresponding to a different one of the two or more candidate UL bands; and
receiving the indication of the selection of the UL band from the user device includes receiving from the user device a RACH procedure message that is sent by the user device using a RACH configuration, of the two or more RACH configurations, that corresponds to the UL band.
Example 7. The method of Example 5 or 6, wherein the system information includes an offset between a UL path loss in the UL band and a DL path loss in the DL band.
Example 8. The method of any one of Examples 1-4, wherein transmitting the indication of the two or more candidate UL bands includes transmitting a radio resource control (RRC) message including the indication of the two or more candidate UL bands.
Example 9. The method of any one of Examples 1-4, further comprising:
before receiving the indication of the selection of the UL band, communicating, by the processing hardware, bi-directionally with the user device using an other UL band for the UL communications and the DL band for the DL communications to the user device.
Example 10. The method of Example 9, wherein receiving the indication of the selection of the UL band includes receiving from the user device a first radio resource control (RRC) message that indicates the UL band.
Example 11. The method of Example 10, further comprising:
after receiving the first RRC message, transmitting, by the processing hardware, a second RRC message to the user device, wherein the second RRC message approves the UL band for the UL communications.
Example 12. The method of Example 11, wherein the second RRC message includes a random access channel (RACH) configuration corresponding to the UL band.
Example 13. The method of any one of Examples 9-12, further comprising:
after receiving the indication of the selection of the UL band, performing, by the processing hardware, a handover that transitions the user device from (i) communicating bi-directionally with the RAN using the other UL band for UL communications from the user device to the first node and the DL band for the DL communications to the user device, to (ii) communicating bi-directionally with the RAN using the UL band for UL communications from the user device to a second node of the one or more nodes and the DL band for the DL communications to the user device.
Example 14. The method of Example 13, wherein performing the handover includes sending the user device a radio resource control (RRC) message indicating that the handover is a UL-only handover.
Example 15. The method of any one of Examples 1-14, wherein communicating bi-directionally with the user device includes using the UL band for UL communications from the user device to the first node and the DL band for DL communications from a second node of the one or more nodes to the user device.
Example 16. The method of any one of Examples 1-15, wherein communicating bi-directionally with the user device excludes using the first operating band for UL communications.
Example 17. The method of any one of Examples 1-16, further comprising:
before receiving the indication of the selection of the UL band, transmitting, by the processing hardware and to the user device, a message that configures the user device to measure, during a measurement gap, a DL signal in at least one of the two or more candidate UL bands.
Example 18. The method of Example 17, further comprising:
before transmitting the message that configures the user device to measure the DL signal, receiving, by the processing hardware and from the user device, a user device capability message,
wherein transmitting the message that configures the user device to measure the DL signal is in response to information, included in the user device capability message, indicating that the user device can use the DL band for DL communications while using at least one of the two or more candidate UL bands for UL communications.
Example 19. The method of any one of Examples 1-16, further comprising:
before receiving the indication of the selection of the UL band, transmitting, by the processing hardware and to the user device, a message that configures the user device to transmit, during a measurement gap, a sounding reference signal in at least one of the two or more candidate UL bands.
Example 20. The method of Example 19, further comprising:
before transmitting the message that configures the user device to transmit the sounding reference signal in the UL band, receiving, by the processing hardware and from the user device, a user device capability message,
wherein transmitting the message that configures the user device to transmit the sounding reference signal in the UL band is in response to information, included in the user device capability message, indicating that the user device can use the DL band for DL communications while using at least one of the two or more candidate UL bands for UL communications.
Example 21. The method of any one of Examples 1-16, further comprising:
receiving, by the processing hardware, a user device capability message from the user device that indicates whether the user device supports communications with decoupled DL and UL bands.
Example 22. The method of any one of Examples 1-16, further comprising:
receiving, by the processing hardware, a user device capability message from the user device that indicates one or more DL/UL band pairs supported by the user device.
Example 23. The method of any one of Examples 1-22, wherein communicating bi-directionally with the user device includes transmitting one or more DL messages to the user device using the DL band, the one or more DL messages including control information for the UL communications in the UL band.
Example 24. The method of Example 23, wherein the control information includes one or more of (i) one or more power control parameters for the UL communications, (ii) one or more timing control parameters for the UL communications, (iii) dynamic grant information for the UL communications, or (iv) configured grant information for the UL communications.
Example 25. The method of any one of Examples 1-24, wherein communicating bi-directionally with the user device includes scheduling the UL communications, and the DL communications to the user device, using time-division duplexing.
Example 26. The method of Example 25, wherein scheduling the UL communications, and the DL communications to the user device, using time-division duplexing includes providing a guard period between an end of a DL transmission by the RAN and a beginning of a UL transmission by the user device.
Example 27. The method of any one of Examples 1-26, wherein the UL band is lower in frequency than the DL band.
Example 28. One or more nodes of a RAN comprising processing hardware configured to perform the method of any one of Examples 1-27.
Example 29. A method implemented by a user device configured to communicate with a radio access network (RAN) that supports communications with user devices using a plurality of operating bands each supporting a plurality of frequency channels, the method comprising:
receiving, from a first node of the RAN, an indication of two or more candidate uplink (UL) bands, the first node using a first operating band for downlink (DL) communications to user devices, and each of the two or more candidate UL bands being outside of the first operating band;
selecting, by processing hardware of the user device and from among the two or more candidate UL bands, a UL band for UL communications from the user device to the RAN;
transmitting an indication of the selection of the UL band to the RAN; and
communicating, by the processing hardware, bi-directionally with the RAN (i) using the UL band for the UL communications from the user device to the RAN and (ii) using a DL band in the first operating band for DL communications from the RAN to the user device.
Example 30. The method of Example 29, wherein transmitting the indication of the selection of the UL band to the RAN includes transmitting a random access channel (RACH) procedure message using a RACH configuration that corresponds to the UL band.
Example 31. The method of Example 30, further comprising:
after transmitting the indication of the selection of the UL band to the RAN, receiving a later RACH procedure message from the RAN, wherein the later RACH procedure message approves the UL band for the UL communications.
Example 32. The method of Example 31, wherein the later RACH procedure message includes one or more parameters for the user device to use for the UL communications, the one or more parameters including:
a sub-carrier spacing; and/or one or more time division duplexing (TDD) configuration parameters.
Example 33. The method of any one of Examples 29-32, wherein receiving the indication of the two or more candidate UL bands includes receiving system information broadcast by a base station of the RAN, the system information including the indication of the two or more candidate UL bands.
Example 34. The method of Example 33, wherein:
the system information includes two or more random access channel (RACH) configurations each corresponding to a different one of the two or more candidate UL bands; and
transmitting the indication of the selection of the UL band to the RAN includes transmitting to the RAN a RACH procedure message using a RACH configuration, of the two or more RACH configurations, that corresponds to the UL band.
Example 35. The method of Example 33 or 34, wherein the system information includes an offset between a UL path loss in the UL band and a DL path loss in the DL band.
Example 36. The method of any one of Examples 29-32, wherein receiving the indication of the two or more candidate UL bands includes receiving a radio resource control (RRC) message including the indication of the two or more candidate UL bands.
Example 37. The method of any one of Examples 29-32, further comprising:
before transmitting the indication of the selection of the UL band, communicating, by the processing hardware, bi-directionally with the RAN using an other UL band for the UL communications and the DL band for the DL communications to the user device.
Example 38. The method of Example 37, wherein transmitting the indication of the selection of the UL band includes transmitting to the RAN a first radio resource control (RRC) message that indicates the UL band.
Example 39. The method of Example 38, further comprising:
after transmitting the first RRC message, receiving, by the processing hardware, a second RRC message from the RAN, wherein the second RRC message approves the UL band for the UL communications.
Example 40. The method of Example 39, wherein the second RRC message includes a random access channel (RACH) configuration corresponding to the UL band.
Example 41. The method of any one of Examples 37-40, further comprising:
after transmitting the indication of the selection of the UL band, transitioning, by the processing hardware, from (i) communicating bi-directionally with the RAN using the other UL band for UL communications from the user device to the first node and the DL band for the DL communications to the user device to (ii) communicating bi-directionally with the RAN using the UL band for UL communications with a second node of the RAN and the DL band for the DL communications to the user device.
Example 42. The method of Example 41, wherein the transitioning includes receiving from the RAN a radio resource control (RRC) handover message.
Example 43. The method of Example 42, wherein the RRC handover message indicating a UL-only handover.
Example 44. The method of any one of Examples 29-43, further comprising:
before selecting the UL band, receiving from the RAN a message that configures the user device to measure, during a measurement gap, a DL signal in at least one of the two or more candidate UL bands,
wherein selecting the UL band includes obtaining a measurement of the DL signal in at least one of the two or more candidate UL bands and selecting the UL band based on the measurement.
Example 45. The method of any one of Examples 29-43, further comprising:
before selecting the UL band, receiving from the RAN a message that configures the user device to transmit, during a measurement gap, a sounding reference signal in at least one of the two or more candidate UL bands; and
transmitting the sounding reference signal to the RAN in the at least one of the two or more candidate UL bands and during the measurement gap.
Example 46. The method of any one of Examples 29-45, further comprising:
transmitting to the RAN a user device capability message indicating that the user device supports communications with decoupled DL and UL bands.
Example 47. The method of any one of Examples 29-45, further comprising:
transmitting to the RAN a user device capability message indicating one or more DL/UL band pairs supported by the user device.
Example 48. The method of any one of Examples 29-47, wherein communicating bi-directionally with the RAN includes receiving from the RAN one or more DL messages using the DL band, the one or more DL messages including control information for the UL communications in the UL band.
Example 49. The method of Example 48, wherein the control information includes one or more of (i) one or more power control parameters for the UL communications, (ii) one or more timing control parameters for the UL communications, (iii) dynamic grant information for the UL communications, or (iv) configured grant information for the UL communications.
Example 50. The method of any one of Examples 29-49, wherein communicating bi-directionally with the RAN includes using time-division duplexing for (i) the UL communications and (ii) the DL communications to the user device.
Example 51. The method of Example 50, further comprising:
switching, by the processing hardware, from a receiving mode to a transmitting mode during a guard period between an end of a DL transmission by the RAN and a beginning of a UL transmission by the user device.
Example 52. The method of any one of Examples 29-51, wherein selecting the UL band for the UL communications is based at least in part on one or both of (i) an interference level, and (ii) a required power backoff.
Example 53. The method of any one of Examples 29-52, wherein communicating bi-directionally with the RAN includes using the UL band for UL communications from the user device to the first node and the DL band for DL communications from a second node of the RAN to the user device.
Example 54. The method of any one of Examples 29-53, wherein the UL band is lower in frequency than the DL band.
Example 55. A user device comprising processing hardware configured to perform the method of any one of Examples 29-54.

1-18. (canceled)

19. A method performed by a user device configured to communicate with a radio access network, RAN, that supports communications with user devices using a plurality of predefined operating bands, each supporting a plurality of frequency channels, the method comprising:
receiving, from the RAN using a first predefined operating band for downlink, DL, communications to user devices including the user device,
a candidate-bands indication of two or more candidate uplink, UL, bands, each of the two or more candidate UL bands pertaining to a second predefined operating band different from the first predefined operating band, and
a measurement configuration enabling measurements of reference signals on the two or more candidate UL bands during a measurement gap;
transmitting, to the RAN, an indication of a UL band selected from among the two or more candidate UL bands for UL communications; and
communicating bi-directionally with the RAN
using the UL band selected for the UL communications from the user device to the RAN and
using a DL band within the first predefined operating band for DL communications from the RAN to the user device.

20. The method of claim 19, wherein the transmitting of the indication of the UL band to the RAN includes transmitting a random access channel, RACH, procedure message using a RACH configuration that corresponds to the UL band.

21. The method of claim 20, further comprising:
after the transmitting of the indication of the UL band to the RAN, receiving a later RACH procedure message from the RAN, wherein the later RACH procedure message indicates an approval to the user device to use the UL band for the UL communications, wherein the later RACH procedure message includes one or more parameters for the user device to use for the UL communications, the one or more parameters including:
a sub-carrier spacing; and/or
one or more time division duplexing, TDD, configuration parameters.

22. The method of claim 19, wherein the receiving of the candidate-bands indication includes obtaining system information broadcast by a base station of the RAN, the system information broadcast including the candidate-bands indication.

23. The method of claim 22, wherein:
the system information broadcast includes two or more random access channel, RACH, configurations, each configuration corresponding to a different one of the two or more candidate UL bands; and
transmitting the indication of the UL band to the RAN includes transmitting, to the RAN, a RACH procedure message using a first RACH configuration among the two or more RACH configurations, wherein the first RACH configuration corresponds to the UL band.

24. The method of claim 22, wherein the system information broadcast includes an offset between a UL path loss in the UL band and a DL path loss in the DL band.

25. The method of claim 19, wherein the receiving of the candidate-bands indication includes processing a radio resource control message including the candidate-bands indication.

26. The method of claim 19, wherein the transmitting of the indication of the UL band includes sending to the RAN a first radio resource control, RRC, message that indicates the UL band, and the method further comprises:
after the sending of the first RRC message, receiving a second RRC message from the RAN, wherein the second RRC message indicates an approval for the user device to use the UL band for the UL communications.

27. The method of claim 19, further comprising:
after the transmitting of the indication of the UL band,
transitioning from initial communicating bi-directionally with the RAN using another UL band for UL communications from the user device to a first node of the RAN and the DL band for the DL communications to the user device
to the communicating bi-directionally with the RAN using the UL band for UL communications with a second node of the RAN and the DL band for the DL communications to the user device.

28. The method of claim 19, further comprising:
obtaining, during the measurement gap, a measurement of a DL signal in at least one of the two or more candidate UL bands, wherein the UL band is selected based on the measurement.

29. The method of claim 19, further comprising:
transmitting a sounding reference signal to the RAN in the at least one of the two or more candidate UL bands according to the measurement configuration.

30. The method of claim 19, further comprising:
transmitting to the RAN a user device capability message indicating that the user device supports communications with decoupled DL and UL bands.

31. The method of claim 19, further comprising:
transmitting to the RAN a user device capability message indicating one or more DL/UL band pairs supported by the user device.

32. A user device comprising processing hardware including a wireless communication interface for interface for communicating with a radio access network, RAN, that supports communications with user devices using a plurality of predefined operating bands, each supporting a plurality of frequency channels,
the wireless communication interface being configured to:
receive, from the RAN using a first predefined operating band for downlink, DL, communications to user devices including the user device,
a candidate-bands indication of two or more candidate uplink, UL, bands, each of the two or more candidate UL bands pertaining to a second predefined operating band different from the first predefined operating band, and
a measurement configuration enabling measurements of reference signals on the two or more candidate UL bands during a measurement gap;
to transmit, to the RAN, an indication of a UL band selected from among the two or more candidate UL bands for UL communications; and
to communicate bi-directionally with the RAN
using the UL band selected for the UL communications from the user device to the RAN and
using a DL band within the first predefined operating band for DL communications from the RAN to the user device.

33. A method performed by a node of a radio access network, RAN, that supports communications with user devices using a plurality of predefined operating bands each supporting a plurality of frequency channels, the method comprising:
transmitting, to a user device using a first predefined operating band for downlink, DL, communications to user devices including the user device, a candidate-bands indication of two or more candidate uplink, UL, bands, each of the two or more candidate UL bands pertaining to a second predefined operating band different from the first predefined operating band;
receiving, from the user device, an indication of a UL band among the two or more candidate UL bands selected for UL communications from the user device to the RAN; and
communicating bi-directionally with the user device
using the UL band for the UL communications from the user device to the RAN and
using a DL band within the first predefined operating band for DL communications from the RAN to the user device.

34. The method of claim 33, further comprising:
after the receiving of the indication of the UL band selected for the UL communications, transmitting a random access channel, RACH, procedure message to the user device, wherein the RACH procedure message indicates an approval of the user device to use the UL band for the UL communications.

35. The method of claim 34, wherein the RACH procedure message includes one or more parameters for the user device to use for the UL communications, the one or more parameters including:
a sub-carrier spacing; and/or
one or more time division duplexing, TDD, configuration parameters, and wherein the transmitting of the candidate-bands indication includes broadcasting system information including the candidate-bands indication.

36. The method of claim 35, wherein:
the broadcasting system information includes RACH configurations, each RACH configuration corresponding to a different one of the two or more candidate UL bands; and
the receiving of the indication of the UL band from the user device includes receiving from the user device a RACH procedure message generated by the user device using a RACH configuration among the RACH configurations, that corresponds to the UL band.

37. A node of a radio access network, RAN, that supports communications with user devices using a plurality of predefined operating bands each supporting a plurality of frequency channels, the node comprising processing hardware including a wireless communication interface configured to
transmit, to a user device using a first predefined operating band for downlink, DL, communications to user devices including the user device, a candidate-bands indication of two or more candidate uplink, UL, bands, each of the two or more candidate UL bands pertaining to a second predefined operating band different from the first predefined operating band;
receive, from the user device, an indication of a UL band among the two or more candidate UL bands selected for UL communications from the user device to the RAN; and
communicate bi-directionally with the user device
using the UL band for the UL communications from the user device to the RAN and
using a DL band within the first predefined operating band for DL communications from the RAN to the user device.
